(19) United States
(12) Patent Application Publication
(10) Pub. No.: US 2003/0044505 A1
(43) Pub. Date: Mar. 6, 2003

(54) Method for producing instantly soluble tea tablets

(76) Inventor: Zhi Chen, Memphis, TN (US)

Correspondence Address: LAW OFFICES OF CLEMENT CHENG, 17220 NEWHOPE STREET #127, FOUNTAIN VALLEY, CA, 92708, US

(21) Appl. No.: 09/945,519

(22) Filed: Aug. 31, 2001

(51) Int. Cl. A23F 3/00

(52) U.S. Cl. 426/597

(57) ABSTRACT

A process for producing instantly soluble tea tablets, comprising of the steps of: creating tea extract by soaking and extracting pulverized dry tea leaves with hot water and isolating the tea extract from the extracted mixture by filtering out insoluble residues; then concentrating said tea extract by evaporating a portion of water from said tea extract; adding food grade additives to adjust flavor; vacuum freeze-drying concentrated flavored tea extract to remove all volatile components to obtain tea powder. The tealeaves can be green tea, black tea, flower tea, red tea and herb tea. Adhesion agents and dispersing agents can be mixed with the freeze-dried tea powder, and then pressing into different three-dimension-shaped tablets.

### BACKGROUND

Tea has been an important part of our lives. It is esteemed as a detoxifying food item in the Chinese culture. People from all over the world use it as a stimulant. Traditionally, tea must be prepared by brewing the tealeaves in the hot water. Instantly soluble tea tablets have not been in use due to the difficulty in maintaining proper taste. People can avoid the trouble of boiling hot water for brewing tea. Instantly soluble tea tablets would be light, easy to be utilized, and sanitary to handle.

### Summary of Introduction

Through this method, the flavor, color, and taste of the tea are preserved in the instantly soluble tea tablets. Tea tablet preparation starts first with steeping the dried tea leaves with hot water, condensing and concentrating the extract, flavoring the tea to desired taste, evaporating and drying the remaining extract into powder. Auxiliary ingredients are added to make the final tea tablets.

This method can be applied but not limited to green tea, fermented tea, Oolong tea, flower tea, and various herbal teas. The instantly soluble tea tablets can be made into cubical, spherical, rectangular, cylindrical, and various shapes.

### DETAILED DESCRIPTION

The process begins with pulverizing or crushing the dried tealeaves to increase the surface area for extraction. De-ionized water is preferred for extraction. The dried leaves can be different fermented tealeaves, baked tealeaves, or any dried tealeaves and herbs. The pulverized tealeaves are immersed in deionized water with temperature ranging from 55° C. to 95° C. for about 15 to 45 minutes. The tea ingredients of dried tealeaves are then extracted into warm deionized water. The insoluble leaves particles, and or impurities are filtered out of the tea solution. Flavoring additives are added to the solution for taste. Commonly available fruit flavor food-grade fragrances are preferred. Tea will be further concentrated through water evaporation and freeze-dried into powder.

Tea powder will be mixed with dispersion agents (such as Sodium Bicarbonate and tartaric acid) and adhesion agents (such as starch or lactose). The dispersion agents react when wet to mix the ingredients of the tablet with the surrounding water. The dispersing agents are comprised of an organic acid such as tartaric acid mixed with either a sodium bicarbonate or starch sodium salt. Other pairs are allowable, as shown by general chemistry principles, but have inferior taste. The preferred weight of sodium bicarbonate added is 3% to 15% of the final product. The preferred weight of tartaric acid added is 2% to 10% of the final product. The preferred weight of starch added is 2% to 3% of the final product when starch is used. The preferred weight of lactose added is 3% to 5% of the final product if lactose is used.

The resulting tea mix is wetted with Ethanol. Ethanol is used as wetting reagent to allow clumping and shaping of the tea powder mixture. Tea powder clumps are pressed into various shaped three-dimensional objects. Pressing machines are available with many different dies and molds. Warming at temperature lower than 50° C. dries the tablets but not too rapidly. For teas not compatible with the wetting reagents, the tea powder mixtures (along with adhesion agents and dispersing agents) can be dry pressed (mixed and poured into the tablet mold and pressed into a tablet directly.) Tablet pressing machines made for medicinal pills and caplets can be used to press tea tablets.

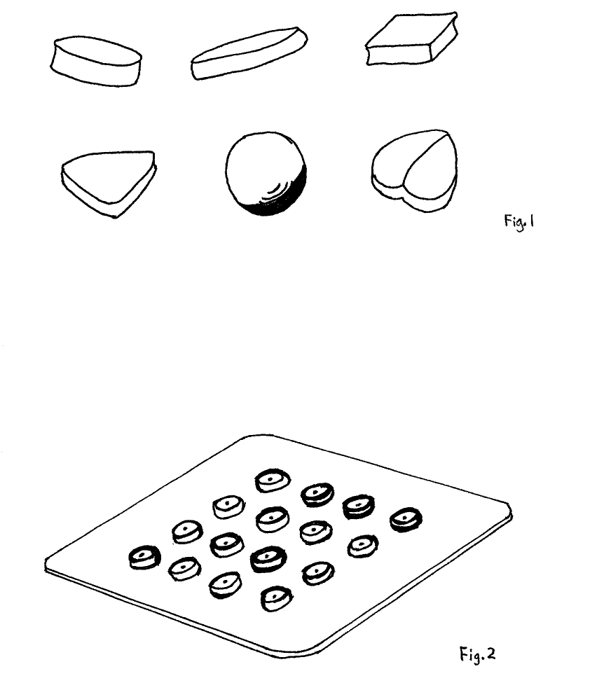

The instantly soluble tea tablets can formed into cubical, spherical, rectangular, cylindrical, and various shapes as seen in FIG. 1. The final products are packed and sealed in the aluminum or plastic foil bubbles as seen in FIG. 2. The user opens the package and dissolves the tablets in hot or cold water before drinking.

1. A process for producing instantly soluble tea tablets, comprising of the steps of:
a. creating tea extract by soaking and extracting pulverized dry tea leaves with hot water and isolating the tea extract from the extracted mixture by filtering out insoluble residues; then
b. concentrating said tea extract by evaporating a portion of water from said tea extract;
c. adding food grade additives to adjust flavor;
d. vacuum freeze-drying concentrated flavored tea extract to remove all volatile components to obtain tea powder,
e. pressing freeze-dried tea powder in a tablet pressing machine.

2. The process of claim 1, wherein said tealeaves are selected from the group of: green tea, black tea, flower tea, red tea and herb tea.

3. The process of claim 1, wherein de-ionized water having a temperature between 55 C to 95C is used for extraction.

4. The process of claim 1, wherein said tealeaves are extracted for 15 to 45 minutes.

5. The process of claim 1, wherein said additives are food-grade fragrances.

6. The process of claim 5, wherein said food-grade fragrances are fruit flavors.

7. The process of claim 1, further comprising the step of: mixing adhesion agents and dispersing agents with the freeze-dried tea powder, and then pressing into different three-dimension-shaped tablets.

8. The process of claim 7, wherein said adhesion agents is either starch or lactose.

9. The process of claim 7, wherein the weight of starch added is 2% to 3% of the final product when starch is used, or the weight of lactose added is 3% to 5% of the final product if lactose is used.

10. The process of claim 7, wherein said dispersing agents are comprised of an organic acid such as tartaric acid mixed with either a sodium bicarbonate or starch sodium salt.

11. The process of claim 7, wherein the weight of sodium bicarbonate added is 3% to 15% of the final product and the weight of tartaric acid added is 2% to 10% of the final product.

12. The process of claim 7, further comprising the step of sealing and vacuum packing tea tablets in plastic or aluminum foil bubbles.

13. A tea tablet comprising:
a. flavored and vacuum freeze-dried tea powder,
b. adhesion agents,
c. dispersing agents, and
d. food-grade fragrances.

14. the tea tablet of claim 13, wherein the adhesion agent is either starch or lactose, wherein the weight of starch added is 2% to 3% of the final product when starch is used, wherein the weight of lactose added is 3% to 5% of the final product when lactose is used.

15. the tea tablet of claim 13, wherein the dispersing agents are sodium bicarbonate and an organic acid, wherein the weight of sodium bicarbonate is 3% to 15% of the final product and the weight of said organic acid is 2% to 10% of the final product.

16. the tea tablet of claim 15, wherein said organic acid dispersing agent is tartaric acid.
